(19) United States
(12) Patent Application Publication
(10) Pub. No.: US 2004/0015780 A1
(43) Pub. Date: Jan. 22, 2004

(54) Position-independent access to data elements in an electronic document

(76) Inventors: Sven Graupner, Mountain View, CA (US); Tilo Nitzsche, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/195,369

(22) Filed: Jul. 16, 2002

(51) Int. Cl. G06F 15/00

(52) U.S. Cl. 715/513

(57) ABSTRACT

A data element in an electronic document is accessed by parsing a header associated with the electronic document for an information pointer tag and the information pointer tag is parsed for a key term. This key term includes an associated path to the data element. The data element is within a document hierarchy associated with the electronic document. In addition, the associated path is utilized to locate the data element in response to finding the key term and the data element is accessed in response to locating the data element.

### BACKGROUND OF THE INVENTION

An electronic document may exist in two representations. When created, read and/or edited by a user, an electronic document is said to be in an external representation, such as American Standard Code for Information Interchange (“ASCII”) formatted text using a markup language. Examples of markup languages include, hypertext markup language (“HTML”), extensible markup language (“XML”) and the like. In general, markup languages are utilized to identify and organize content of the electronic documents.

The internal representation is in a form of a tree stored in a computer's memory. Several standards exist for how this tree (e.g., parse tree, document hierarchy, etc.) is laid out. One of these standards is a Document Object Model (“DOM”). The DOM defines the layout of the internal tree and the methods software applications use to access data contained in the electronic document. By way of an example, typically an XML document has a single outermost element, called the “root element” which, in turn, may contain other elements, nested in a hierarchical manner. Additionally, each element contains a start and a stop “tag” which respectively denote the beginning and the end of the element. Each element (other than the root element) has a single parent or trunk from which it originates. Each element (including the root element) may have one or more children or branches which originate from it. In this manner, a hierarchical tree may be described. Thus, if an XML document is laid out in this structured, hierarchical tree, it is possible to describe a path to any element within the XML document.

Furthermore, electronic documents may be passed (e.g., sent, received, etc.) between devices (e.g., computers, routers, printers, etc.). Recently, software applications built upon the model of exchanging data in the form of electronic documents have become popular. When sending the external representation of an electronic document across a network, a protocol is used for the transmission. The protocol defines the data layout of exchanged messages and the rules according to which message exchanges happen. The data layout of a message consists of two sections, a body or payload and a header. To use a package being sent via the U.S. Mail as an analogy, the body may be thought of as the contents of the package while the header includes the address of the sender and the recipient.

In contrast to conventional network protocols, which utilize specially defined binary representations for message headers and bodies, the software applications utilize documents for representing header and body sections. A message thus consists of at least of two documents: the header document and the body or payload document. The header document is used to specify address and routing information. The body or payload document contains the content of the electronic document. Usually, the header document and the body or payload document are wrapped by an envelope data structure that is also constituted as a document.

To processing a conventional electronic document, computing devices are programmed to carry out instructions according to particular protocols. As computer technology continues to evolve and improve, the various protocols are modified. Relatively major modifications or revisions may require installing a new version of the protocol in some or all of the network devices. This may entail shutting down each device to accomplish the install. In a worldwide, distributed system, such as the Internet, many millions of devices may be required to be upgraded. Thus, upgrading these devices results in the expenditure of vast amounts of time and money.

### SUMMARY OF THE INVENTION

In an embodiment, the invention pertains to a method of accessing a data element in an electronic document. In this method, a header associated with the electronic document is parsed for an information pointer tag and the information pointer tag is parsed for a key term. The key term includes an associated path to the data element. The data element is within a document hierarchy associated with the electronic document. In addition, the associated path is utilized to locate the data element in response to finding the key term and the data element is accessed in response to locating the data element.

### BRIEF DESCRIPTION OF THE DRAWINGS

Embodiments of the invention are illustrated by way of example and not limitation in the accompanying figures in which like numeral references refer to like elements, and wherein:

FIG. 1 is a block diagram of a location information module, according to an embodiment of the invention;

FIG. 2 is a flow diagram of a method for resolving and extracting a multi-level path from an electronic document, according to an embodiment of the invention;

FIG. 3 is an electronic document, according to an embodiment of the invention;

FIG. 4 is a header, according to an embodiment of the invention;

FIG. 5 is a block diagram of a system, according to an embodiment of the invention;

FIG. 6 is a flow diagram of a method for processing a header of a message, according to an embodiment of the invention;

FIG. 7 is an illustration of a DOM tree, according to an embodiment of the invention;

FIG. 8 is an illustration of a manner in which an element of a DOM tree is accessed, according to an embodiment of the invention; and

FIG. 9 is an illustration of a manner in which another element of a DOM tree is accessed, according to an embodiment of the invention.

### DETAILED DESCRIPTION

For simplicity and illustrative purposes, the principles of the invention are described by referring mainly to an embodiment thereof, particularly with references to a system to access routing information in an electronic document. However, one of ordinary skill in the art would readily recognize that the same principles are equally applicable to, and may be implemented in, a system capable of accessing various forms of information within an electronic document, and that any such variations are within the scope of the invention. While in the following description numerous specific details are set forth in order to provide a thorough understanding of an embodiment of the invention, in other instances, well known methods and structures have not been described in detail so as not to obscure the invention.

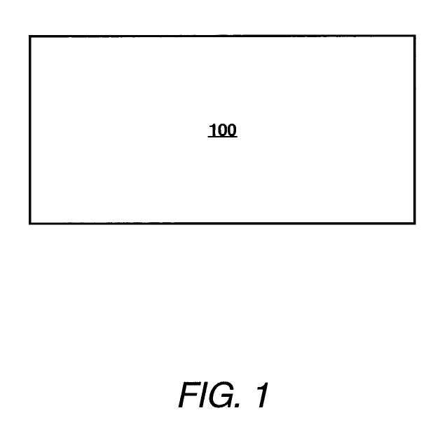

FIG. 1 is a block diagram of a location information module (“LIM”) 100, according to an embodiment of the invention. The LIM 100 is configured to process information pointer tags (e.g., XPath expressions, metadata tags, etc.) within a header portion of an electronic document. In general, information pointer tags are markup codes indicating the presence of a particular type of information. A specific example of an information pointer tag is an XPath expression. XPath expressions are defined as XML code utilized for addressing parts (e.g., data elements) of an XML document. Of course, one skilled in the art would be familiar with other information pointer tags such as: “img src” used to define a path to an image file; “href” used to define a path to a hyperlink; and the like.

As described in greater detail hereinbelow, an XPath expression may be included in the header portion of the electronic document. The XPath expression may include a path (e.g., a route, a pointer, etc.) to a data element within a body portion of the electronic document. The path may include an identifying “key term”. In general, the key term may be defined as an alias or “handle” with which the data element may be identified and/or located within the header and/or body of the electronic document. In addition, the XPath expression may include a plurality of paths, each path having a corresponding key term. In this manner, multiple data elements may be identified within the body of the electronic document.

This identified path may be utilized to navigate through a document hierarchy of the electronic document and locate the associated data element. In general, data elements may include any enumerated type of information. Particular examples of types of information included within data elements include the following: sender address, recipient address, router addresses, size, date, time, name, and the like.

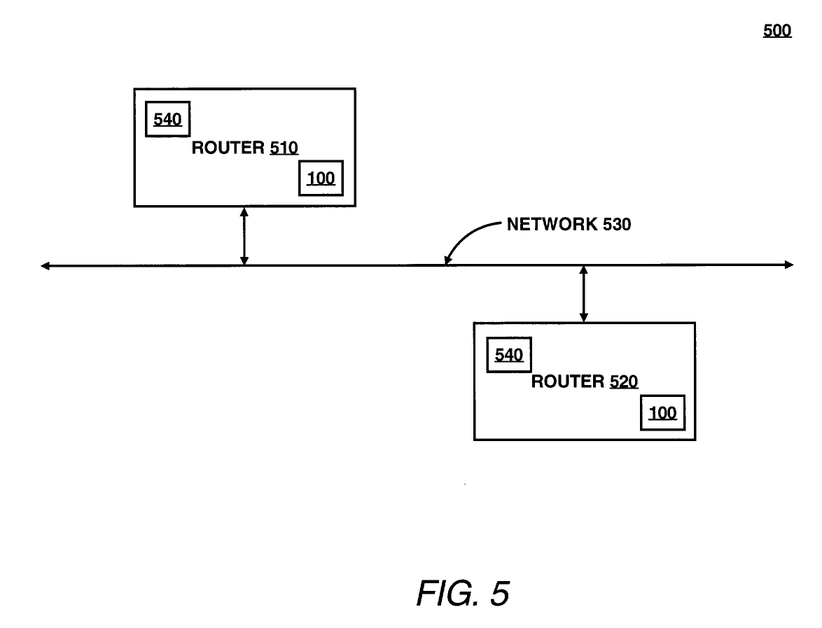

According to an embodiment of the invention, the LIM 100 may operate within any reasonable type of computing device (An example of a specific environment is shown in FIG. 5). Specific examples of computing devices in which the LIM 100 may operate include: personal computers, personal digital assistants, routers, domain name servers, firewalls, switches, and the like. In addition, the LIM 100 may operate in conjunction with an XML processing module 540 (shown in FIG. 5). The XML processing module 540 may be configured to generate a document hierarchy for the electronic document and utilize the path identified by the LIM 100 to locate the associated data element. As described in greater detail hereinbelow, the XML processing module 540 may further be configured to perform various other functions based on XML code.

In an embodiment of the invention, a data element, located essentially anywhere within the electronic document, may be accessed based on the path included in the header of the electronic document. Thus, the computing device need not be required to utilize pre-defined locations or pre-specified path information order to access data elements in the electronic document. For example, if the LIM 100 were used to extract routing information for a document exchange system, the routing information would not have to be in predefined locations. This relieves the computing device from the need to be re-programmed, upgraded or patched when new versions of protocols emerge.

In another embodiment of the present invention, the path may comprise a plurality of sub-paths thus, providing multi-level access (e.g., a multi-level path). These sub-paths may be identified and concatenated into an access path. For example, the plurality of sub-paths may include a root path and at least one relative path that, taken together, describe a path from the root element to a particular element.

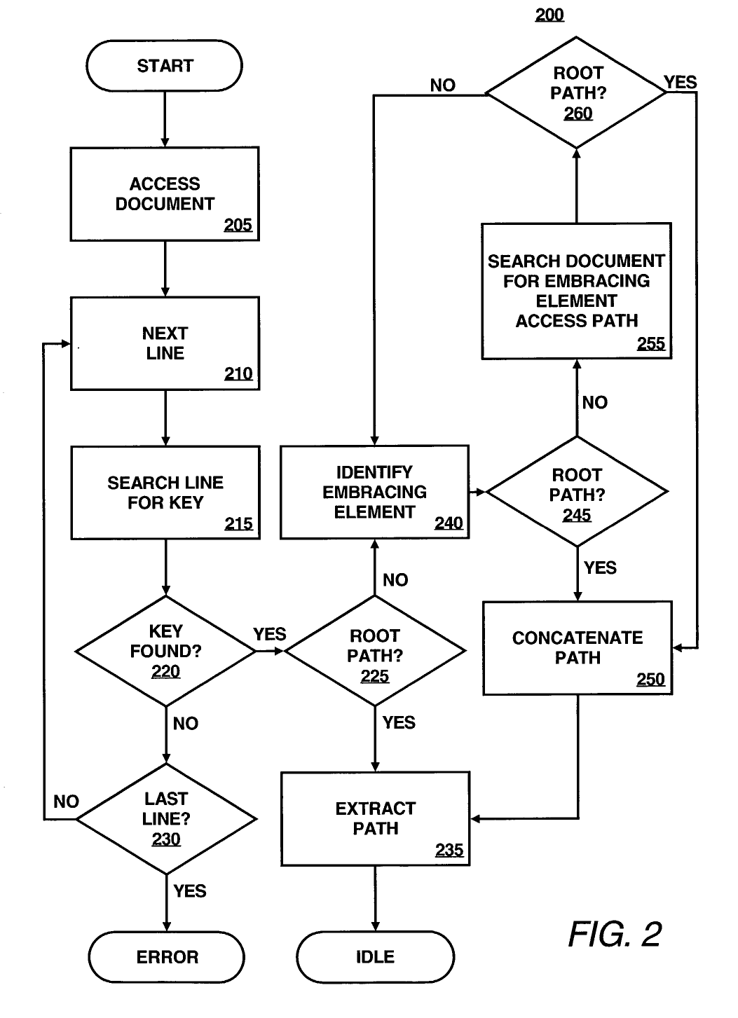

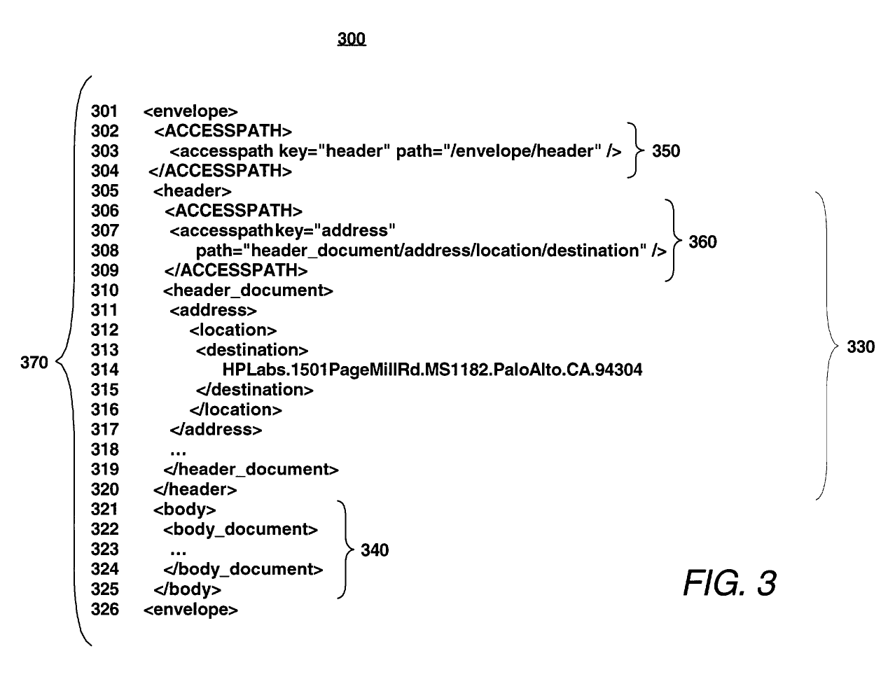

FIG. 2 is a flow diagram of a method 200 for processing a multi-level access path from an electronic document, according to an embodiment of the invention. The following description of FIG. 2 is made with particular reference to a document 300 (see FIG. 3). Accordingly, the LIM 100 may receive an electronic document (e.g., the document 300) containing a header portion and a body portion, at step 205. In addition, the LIM 100 may parse the document 300 to locate a key element, such as the destination address.

At step 210, the LIM 100 may access the next line (or first line in the initial pass) of the document 300.

At step 215, the line is searched (e.g., parsed) by the LIM 100 for the key element. At step 220, if the LIM 100 determines that the key element has been found, the LIM 100 is configured to proceed to step 225. Conversely, if at step 220 the LIM 100 determines that the key element has not been found, the LIM I 00 further determines, at step 230, whether the last line of the document 300 has been accessed. For example, at step 215, a search of the line 301 will fail to find the key element (“address” in this example). Therefore, the LIM 100 determines, at step 220, that the key element has not been found. In addition, at step 230, the LIM 100 may determine that line 301 is not the last line and thus the next line is accessed at step 210. This may continue until the LIM 100 searches line 307 for the key element. At which point, the LIM 100 may determine, at step 220, that the key element has been found and the path associated with the key element is identified. For example, the LIM 100 may identify the following access path with the key element found at line 307:

path=“header_document/address/location/destination”

At step 225, the LIM 100 is configured to determine whether a root path has been found. In response to determining that the root path has been found, the LIM 100 extracts the root path to the key element and the LIM 100 idles until the location of another key element is desired. Conversely, if at step 225 the LIM 100 determines that the root path has not been found, the LIM I 00 may identify a next embracing element of the key element at step 240. The term “embracing element” is used to describe an element which directly bounds or encloses another element. For example, at step 225, in response to determining that the path at line 308 is not preceded by an “/”, the LIM 100 may identify the header 330 as the embracing element at step 240.

In response to identifying the next embracing element at step 240, the LIM 100 may determine whether the identified embracing element is the outer or root element at step 245. If, at step 245, the LIM 100 determines that the identified embracing element is the root element, the LIM 100 may concatenate the path at step 250 and extract the path at step 235. If, at step 245, the LIM 100 determines that the identified embracing element is not the root element, at step 255, the LIM 100 may search the document 300 for a path which includes the identified embracing element as the last element of the path. For example, at step 255, in a manner similar to steps 205-230, the LIM 100 may search the document 300 for an access path ending with “header”. Such an access path is identified by the LIM 100 one level up, at line 303 which recites the following:

<accesspath key=“header” path=“/envelope/header”/>

At step 260, the LIM 100 determines whether the identified path is a root path. If at step 260 the LIM 100 determines that the identified path is not a root path, the LIM 100 may identify an embracing element at step 240. If, at step 260, the LIM 100 determines that the identified path is a root path, the LIM 100 may, at step 250, concatenate the paths identified at steps 255 and 215 and extracted at step 235. For example, at step 255, the LIM 100 determines the path:

path=“/envelope/header”.

At step 260, the LIM 100 determines that this path is a root path. Therefore, this path and the path:

path=“header_document/address/location/destination”

identified by the LIM 100 at step 215 are concatenated by the LIM 100 to generate the following path:

path=“/envelope/header/header_document/address/location/destination”

at step 250. This access path is extracted by the LIM 100 at step 235 and may be utilized by the XML processing module 540 to locate the destination address within the document 300.

FIG. 3 is an electronic document 300, according to an embodiment of the invention. As shown in FIG. 3, the document 300 includes a header 330 (lines 305 to 320) and a body 340 (lines 321 to 325) section. Access paths (e.g., routes, paths, etc.) to various elements in the header 330 are included in XPath expressions 350 and 360 within the document 300. Additionally, this access path information is subdivided into two levels.

A first level, XPath expression 350, defines the access path where the header 330 is located in the document 300. A second level, XPath expression 360, is located within the header 330 and is utilized to define the access path where an address to the destination is located within the document 300. The document 300 is defined within the bounds of an envelope 370 section (lines 301 to 326). In this regard, the envelope 370 is the root or outermost element of the document 300.

As shown in FIG. 3, each access path may be defined with respect to its embracing element. Therefore, the access path is not necessarily a root path (e.g., a path from the root element), but rather, a relative path. For example, the LIM 100 may be configured to search the document 300 for an access path element with keyword “address”. The result of such a search for the document 300 produces:

<accesspath key=“address” path=“header_document/address/location/destination”/>

The above defines the relative or trailing part of the root path. Since this access path is relative to its embracing scope (e.g., the access path does not include a leading “/”), further steps may be performed in order to extract the complete multi-level access path component. Due to the location of the XPath expression 360 being within the header 330 section (where the “address” key element has been found) the document 300 is further searched for access paths ending with “header”. Such an access path is found one level up, at line 303 which recites the following:

<accesspath key=“header” path=“/envelope/header”/>

Due to the fact that the above access path is a root path (e.g., it starts from the outermost element as indicated by the leading “/” in the access path), the extraction of the access path for the key element “address” can be completed by concatenating all access paths found along the way. Therefore, the final access path to the data element with key element equal to “address” is:

“/envelope/header”+“header_document/address/location/destination”=“/envelope/header/header_document/address/location/destination”.

In this manner, the destination address:

“HPLabs.1501PageMillRd.MS1182.PaloAlto.CA.94304”

may be found. A more detailed description of resolving and extracting multi-level access paths from electronic documents may be found hereinabove, in FIG. 2.

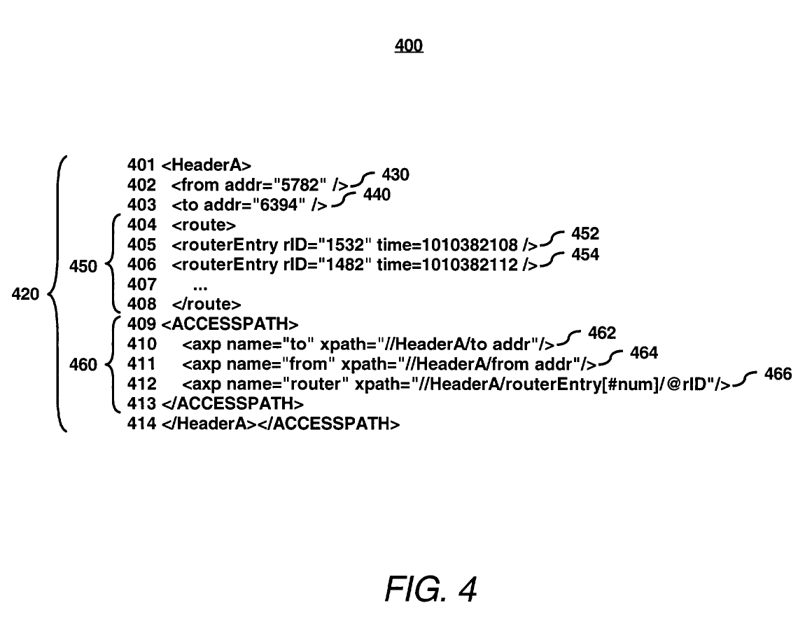

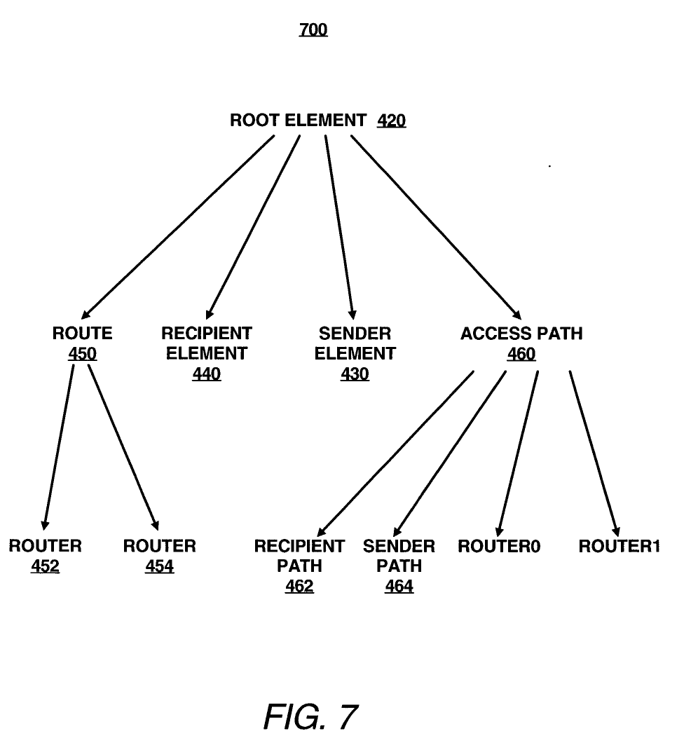

FIG. 4 is a header 400 of an electronic document according to an embodiment of the invention. In this regard, the header 400 includes a root element 420 which begins at “<HeaderA>” line 401 (line numbers added for clarity) and ends at “</HeaderA>” line 414. The root element 420 includes a sender element 430 at line 402, recipient element 440 at line 403, route element 450 beginning at line 404 and ending at line 408 and an XPath expression 460 beginning at line 409 and ending at line 414. An example of a parsed document hierarchy of header 400 is illustrated in FIG. 7.

In FIG. 4, the header 400 is related to a software application for routing electronic documents. In this regard, both the sender element 430 and recipient element 440 point to a respective address. The address assigned to the sender element 430 is utilized to store an identifying number (e.g., 5782) for a device sending the electronic document (e.g., sender, sending device, etc.). The address assigned to the recipient element 440 is utilized to store an identifying number (e.g., 6394) for a device receiving the electronic document (e.g., recipient, receiver, receiving device, etc.).

The route element 450 includes a plurality of router elements 452-454. Each router element 452-454 represents a “node” or “hop” that the electronic document has taken as it is sent from the sending to the receiving device. The router elements 452-454 are designated according to their respective listed order from 0 to n, where n equals the number of “hops” minus 1. For example, the first router element 452 at line 405 is designated “routerEntry0” and at line 406, the router element 454 is designated “routerEntry1”. Each router element 452-454 includes a respective “rID” element. The address assigned to the rID element within the routerEntry0 element is utilized to store the number “1532”. The address assigned to the rID element within the routerEntry1 element is utilized to store the number “1482”. Additionally, each router element 452-454 includes a respective time stamp indicating the arrival time of the electronic document. Furthermore, the router elements 452-454 depicted are merely by way of example and as such are not meant to represent actual device identifiers. In this regard, there may be fewer hops or more hops (as illustrated by the ellipsis at line 407) in an actual route element.

The XPath expression 460 includes a plurality of location paths 462-466 for a variety of different elements. The elements include: a recipient path 462 at line 410; a sender path 464 at line 411; and a router path 466 at line 412 respectively. Thus, as shown in FIG. 4, an address for a recipient (e.g., the recipient path 462) of the electronic document having the header 400 is found within the address assigned to the recipient element 440 within the root element 420.

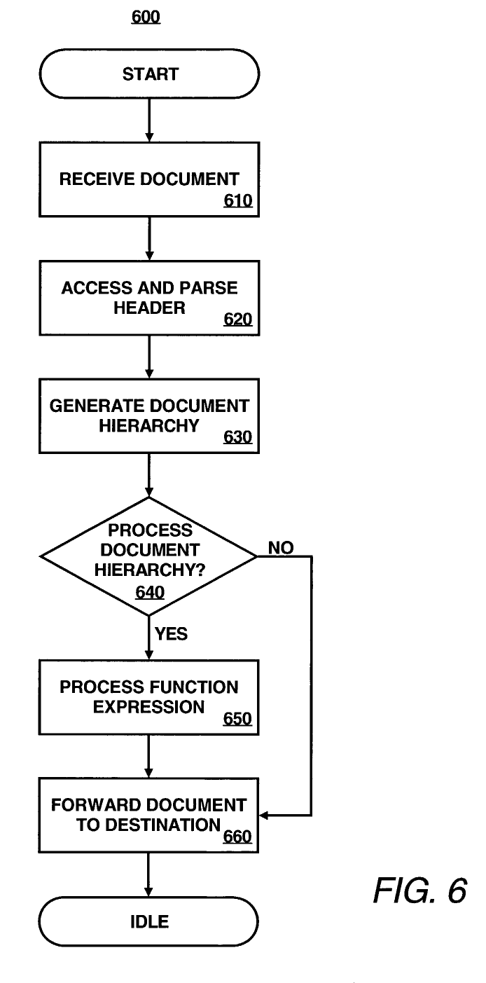

Within the router path 466, a function expression “#num” is utilized to indicate a loop should be performed. Typically, this type of function expression is processed by an XML module, such as an XML processing module 540 shown in FIG. 5. In the loop, the #num markers are iteratively replaced with values from 0 to n where n is the last #num marker. Each number represents a hop count or number of hops in a path from the sending device to the receiving device and may be utilized to uniquely identify each routing device in its respective order within the path. Therefore, the #num of a first router element is replaced with a value of 0, the #num of a second router element is replaced with a value of 1, and so forth. Thus, as shown in FIG. 6, an address for the first router (i.e., “router0”) in the path from the sender to the recipient is found within the router element 452 within the root element 420.

FIG. 5 is a block diagram illustrating an environment 500 according to an embodiment of the invention. As shown in FIG. 5, the environment 500 may include a router 510, a router 520 and a network 530.

The routers 510 and 520 may be configured to at least provide the capability of known routers. According to an embodiment of the invention, the routers 510 and 520 may be configured to process markup code within an electronic document. In this regard, the routers 510 and 520 may include an XML processing module 540 configured to generate a document hierarchy based on the markup code within the electronic document. The routers 510 and 520 may further include the LIM 100 configured to process XPath expressions and identify a path to an address within the document hierarchy as described herein. This identified address may be utilized by the routers 510 and 520 to send the electronic document.

The network 530 may be configured to provide a communication path for one or more network devices to communicate with one or more other network devices. Additionally, the network 530 may be the Internet, a public switched telephone network, a local area network, private wide area network, wireless network, and the like.

Although not illustrated, the environment 500 may also include any reasonable number of additional components, e.g., clients, workstations, servers, printer spoolers, repeaters, hubs, bridges, routers, etc. Furthermore, it is within the scope of the invention that some or all of the functionality of the environment 500 may be subsumed within a single device. Accordingly, the environment 500 described is for illustrative purposes only and thus not meant to limit the invention in any respect.

The routers 510 and 520 and other components or sites on the network 530 may communicate with each other, through network 530, using network enabled code. The network enabled code may include, for example, an Internet Protocol (IP) code, an Internet Protocol Next Generation (IPng) code or data, a Hypertext Markup Language (HTML), a Dynamic HTML, an Extensible Markup Language (XML), an Extensible Stylesheet Language (XSL), and the like.

As described hereinabove, in an embodiment of the invention, a data element (e.g., information, data, etc.) may be accessed from essentially anywhere within the electronic document. More particularly, the router 510 may access data elements utilizing an identifier (e.g., key element, etc.). Thus, the router 510 need not be required to utilize actual locations or pre-specified path information programmed in advance in order to access data elements in the electronic document. This relieves router 510 from the need to be re-programmed, upgraded or patched when new versions of protocols emerge.

An access path may be utilized to describe a “location path” (e.g., a route, set of directions, etc.) to a particular data element of the document hierarchy. The location path to the particular data element includes one or more “location steps”, each step identifying one level in the document hierarchy. The location steps are separated from each other by a forward slash “/”. By following the location steps down through the hierarchical tree, the particular data element may be found. In the following description of FIG. 6, a document hierarchy and a manner in which an access path may be utilized to navigate the document hierarchy is described in greater detail.

In the following description of FIG. 6, a method 600 is utilized to transmit an electronic document from a sender (i.e., a computing device) to a recipient (i.e., a second computing device) utilizing a computing environment, such as the environment 500 illustrated in FIG. 5. Therefore, the description of FIG. 6 will make particular reference to the environment 500 described in FIG. 5. In this regard, the electronic document may pass through a plurality of routers, such as routers 510 and 520. However, the invention is not limited to the description of the method 600 or the environment 500, but rather, as is known to those skilled in the art, other embodiments of the invention may utilize various other methods and computing environments and thus, are within the scope of the invention. Furthermore, the term, “electronic document” is not meant as a limitation, but rather, is used as a term of art to describe computer readable electronic content.

FIG. 6 is a flow diagram of the method 600 for processing a header of an electronic document, according to an embodiment of the invention. As shown in FIG. 6, the method 600 is initiated in response to receiving the electronic document at step 610. For example, the router 520 may receive the electronic document from the router 520. In this embodiment, the electronic document includes a header file similar to the header 400.

At step 620, the header file is accessed and parsed. For example, an XML processing module 540 within the router 520 may access and a parse the header file 400.

At step 630, a document hierarchy based on the parsed header file is generated. For example, a document hierarchy similar to the document hierarchy depicted in FIG. 7 may be generated by the XML processing module 540.

At step 640, it is determined whether processing of the document hierarchy is indicated. For example, if it is determined that a function expression is present, the function expression may be processed at step 650. If, at step 640, it is determined that further processing of the document hierarchy is not indicated, the LIM 100 may identify a path to the destination address and this path may be utilized to locate the destination address in the document hierarchy at step 660.

At step 650, the document hierarchy is further processed. For example, an XPath function expression may be utilized to uniquely identify a plurality of addresses within an XPath expression. In a specific example, a #num marker may be utilized to indicate where to insert a value of an iterator (e.g., a counter) variable. In this manner, a plurality of similar elements within the XPath expression 460 may be uniquely identified and thus, a unique path may be described to access each of the plurality of similar elements. In this particular example, the XML processing module 540 may be configured to replace each #num function marker with a corresponding value of the iterator variable. Following the step 650, the document hierarchy may be utilized to locate the destination address at step 660.

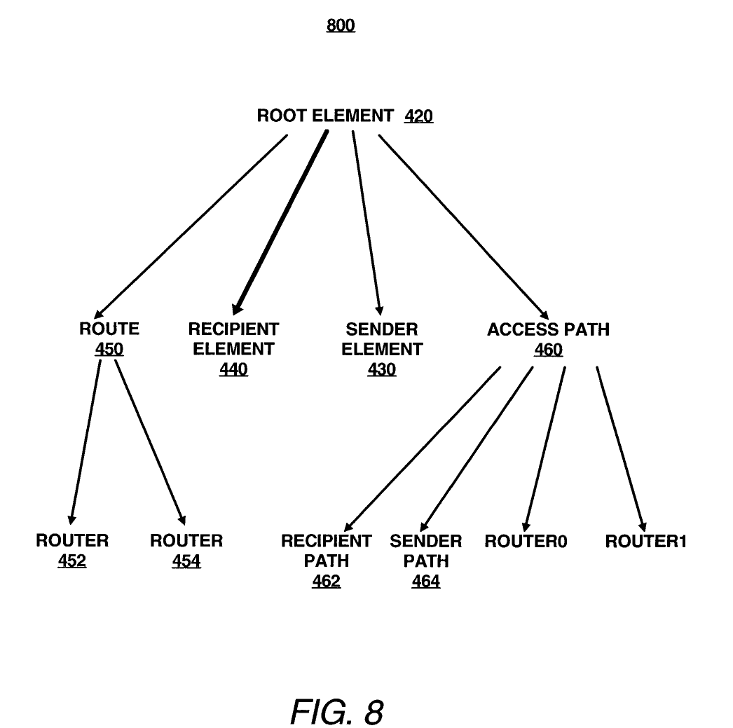

At step 660, according to one embodiment, the LIM I 00 may identify a path (see FIG. 2) and the path may be utilized to navigate the document hierarchy and locate the destination address. For example, as shown in FIG. 8, the path may be utilized to locate the recipient element 440 within the document hierarchy. Additionally, the router 520 may be configured to access and utilize the located recipient element 440 to forward the electronic document to the destination address. Moreover, according to various other embodiments, the LIM 100 may be configured to identify any other data elements within the document hierarchy. Following the step 660, the router 520 may idle until a next document is received.

FIG. 7 is an illustration of a document hierarchy 700, according to an embodiment of the invention. As shown in FIG. 7, the document hierarchy 700 is an illustration based on the header 400. Accordingly, FIG. 7 is described with reference to FIG. 4.

As shown in FIG. 7, all elements of the header 400 branch directly or indirectly from the root element 420. In this regard, the following elements directly branch from the root element 420: route element 450, recipient element 440, sender element 430, and XPath expression 460. Additionally, router element 452 and router element 454 branch directly from the route element 450 (indirectly from the root element 420). Furthermore, recipient path 462, sender path 464, router0 and router1 elements branch directly from the XPath expression 460 (indirectly from the root element 420).

FIG. 8 is an illustration of a manner in which an element of the document hierarchy 700 is accessed, according to an embodiment of the invention. Accordingly, FIG. 8 is described with reference to FIGS. 4, 6, and 7. Additionally, only those aspects that differ between FIGS. 7 and 8 are described herein below.

As described hereinabove, to access to the recipients' address, the XML processing module 540 generates the document hierarchy, the LIM 100 identifies the path to the recipients' address, the path is utilized to locate the recipients' address within the document hierarchy 700, and the recipients' address is accessed. This process is illustrated by way of a relatively thicker line to the recipient element 440 from the root element 420.

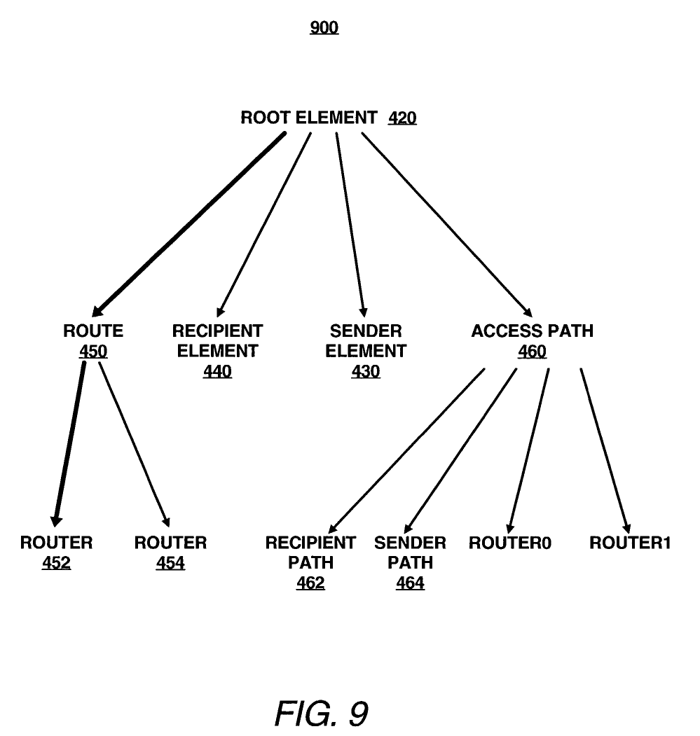

FIG. 9 is an illustration of a manner in which another element of the document hierarchy 700 is accessed, according to an embodiment of the invention. Accordingly, FIG. 9 is described with reference to FIGS. 4, 6, and 7. Additionally, only those aspects that differ between FIGS. 7 and 9 are described herein below.

To access to the address of the first router in the path from the sender to the recipient, the XML processing module 540 generates the document hierarchy, the LIM 100 identifies the path to the first routers' address, the path is utilized to locate the first routers' address within the document hierarchy 700, and the first routers' address is accessed. This process is illustrated by way of a relatively thicker line to the router0 element from the root element 420 by way of the route element 450 in the document hierarchy 700.

Moreover, it is to be understood that the invention is not limited to the document hierarchy 700 illustrated in FIGS. 7-9, but rather, the invention may include any reasonable representation of a document object model. Accordingly, the document hierarchy depicted in FIGS. 7-9 is for illustrative purposes only and thus is not meant to limit the present invention in any respect.

The methods 200 and 600 may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form. Examples of computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the program(s) on a CD ROM or via Internet download. In a sense, the Internet itself, as an abstract entity, is a computer readable medium. The same is true of computer networks in general.

What has been described and illustrated herein is an embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method of accessing a data element in an electronic document, said method comprising steps of:
parsing a header associated with said electronic document for an information pointer tag;
parsing said information pointer tag for a key term, said key term including an associated path to said data element, said data element being within a document hierarchy associated with said electronic document;
utilizing said associated path to locate said data element in response to finding said key term; and
accessing said data element in response to locating said data element.

2. The method according to claim 1, further comprising:
determining a presence of a function expression; and
processing said function expression in response to said function expression being present.

3. The method according to claim 2, wherein said function expression includes a #num marker and said step of processing said function expression comprises:
replacing said #num marker with a number in response to said #num marker being present, said number being representative of a hop count in a path from a sending device to a receiving device.

4. The method according to claim 1, wherein said associated path includes a plurality of relative paths and said method further comprises:
parsing said header for a first information pointer tag, said first information pointer tag including said key term, wherein a first relative path of said plurality of relative paths is associated with said key term;
identifying a first embracing element associated with said first information tag;
parsing said header for a second information pointer tag, said second information pointer tag including a second relative path of said plurality of relative paths, wherein said second relative path includes said first embracing element;
concatenating said plurality of relative paths to generate said associated path in response to said second relative path including a root element associated with said electronic document; and
utilizing said associated path to locate said data element within said document hierarchy.

5. The method according to claim 1, wherein said electronic document is in XML format.

6. The method according to claim 5, wherein said identification pointer tag is an XPath expression.

7. A computer readable medium on which is embedded computer software, said software comprising executable code for performing a method of accessing a data element in an electronic document, said method comprising steps of:
parsing a header associated with said electronic document for an information pointer tag;
parsing said information pointer tag for a key term, said key term including an associated path to said data element, said data element being within a document hierarchy associated with said electronic document;
utilizing said associated path to locate said data element in response to finding said key term; and
accessing said data element in response to locating said data element.

8. The method according to claim 7, further comprising:
determining whether a function expression is present; and
processing said function expression in response to said function expression being present.

9. The method according to claim 8, wherein said function expression includes a #num marker and said step of processing said function expression comprises:
replacing said #num marker with a number in response to said #num marker being present, said number being representative of a hop count in a path from a sending device to a receiving device.

10. The method according to claim 7, wherein said step of parsing said information pointer tag further comprises identifying said associated path based on a key element, said key element being associated with said data element.

11. The method according to claim 10, wherein said associated path includes a plurality of relative paths and said step of identifying further comprises steps of:
parsing said header for a first information pointer tag, said first information pointer tag including said key term, wherein a first relative path of said plurality of relative paths is associated with said key term;
identifying a first embracing element associated with said first information tag;
parsing said header for a second information pointer tag, said second information pointer tag including a second relative path of said plurality of relative paths, wherein said second relative path includes said first embracing element;
concatenating said plurality of relative paths to generate said associated path in response to said second relative path including a root element associated with said electronic document; and
utilizing said associated path to locate said data element within said document hierarchy.

12. The method according to claim 7, wherein said electronic document is in XML format.

13. The method according to claim 12, wherein said identification pointer tag is an XPath expression.

14. A system for routing an electronic document comprising a plurality of routers operable to route said electronic document, wherein each router is configured to:
receive said electronic document;
utilize an information pointer tag to identify a path, said path being associated with an address for a next destination;
accessing said address; and
transmit said electronic document to said next destination.

15. The system according to claim 14, wherein each router is further configured to parse a header associated with said electronic document to generate a document hierarchy, said document hierarchy having a plurality of branches, wherein a branch of said plurality of branches includes said address.

16. The system according to claim 15, wherein each router is further configured to parse said information pointer tag to determine said location of said branch including said address.

17. The system according to claim 16, wherein each router is further configured to process a marker within said electronic document.

18. An apparatus for accessing a data element in an electronic document, said apparatus comprising:
means for parsing a header associated with said electronic document for an information pointer tag;
means for parsing said information pointer tag for a key term, said key term including an associated path to said data element, said data element being within a document hierarchy associated with said electronic document;
means for utilizing said associated path to locate said data element in response to finding said key term; and
means for accessing said data element in response to locating said data element.

19. The apparatus according to claim 18, further comprising:
means for determining a presence of a function expression; and
means for processing said function expression in response to said function expression being present.

20. The apparatus according to claim 19, wherein said function expression includes a #num marker and said means for processing said function expression comprises:
means for replacing said #num marker with a number in response to said #num marker being present, said number being representative of a hop count in a path from a sending device to a receiving device.

21. The apparatus according to claim 18, wherein said associated path includes a plurality of relative paths and said method further comprises:
means for parsing said header for a first information pointer tag, said first information pointer tag including said key term, wherein a first relative path of said plurality of relative paths is associated with said key term;
means for identifying a first embracing element associated with said first information tag;
means for parsing said header for a second information pointer tag, said second information pointer tag including a second relative path of said plurality of relative paths, wherein said second relative path includes said first embracing element;
means for concatenating said plurality of relative paths to generate said associated path in response to said second relative path including a root element associated with said electronic document; and
means for utilizing said associated path to locate said data element within said document hierarchy.

22. A method comprising steps of:
generating a document hierarchy based on an electronic document, said document hierarchy having a plurality of branches, wherein a branch of said plurality of branches includes a data element;
identifying a key term within a header associated with said electronic document, said key term including a path associated with said data element; and
accessing said data element from said document hierarchy based on said path.

23. The method according to claim 22, further comprising:
determining whether a function expression is present; and
processing said function expression in response to said function expression being present.

24. The method according to claim 23, wherein said function expression includes a #num marker and said step of processing said function expression comprises:
replacing said #num marker with a number in response to said #num marker being present, said number being representative of a hop count in a path from a sending device to a receiving device.

25. The method according to claim 22, wherein said key term is associated with an information pointer tag.

26. The method according to claim 22, further comprising:
parsing said electronic document in response to receiving said electronic document; and
generating said document hierarchy based on said parsed electronic document.

27. A method comprising steps of:
receiving an electronic document;
parsing said electronic document in response to receiving said electronic document;
generating a document hierarchy based on said parsed electronic document, said document hierarchy having a plurality of branches, wherein a branch of said plurality of branches includes a data element;
determining whether a function expression is present within said electronic document;
processing said function expression in response to said function expression being present, wherein said document hierarchy is modified based on said processed function expression;
parsing a header associated with said electronic document for an information pointer tag;
parsing said information pointer tag for a key term, said key term including an associated path to said data element;
utilizing said associated path to locate said data element in response to finding said key term; and
accessing said data element in response to locating said data element.

28. The method according to claim 27, wherein said function expression includes a #num marker and said step of processing said function expression comprises:
replacing said #num marker with a number in response to said #num marker being present, said number being representative of a hop count in a path from a sending device to a receiving device.

29. The method according to claim 27, wherein said information pointer tag includes a location of said accessed data element within said document hierarchy.

30. A location information module executing on a computing device, said location information module configured to:
parse a header associated with an electronic document for an information pointer tag;
parse said information pointer tag for a key term, said key term including an associated path to a data element, said data element being within a document hierarchy associated with said electronic document; and
utilizing said associated path to locate said data element in response to finding said key term.

31. The location information module according to claim 30, wherein said associated path includes a plurality of relative paths and said location information module being further configured to:
parse said header for a first information pointer tag, said first information pointer tag including said key term, wherein a first relative path of said plurality of relative paths is associated with said key term;
identify a first embracing element associated with said first information tag;
parse said header for a second information pointer tag, said second information pointer tag including a second relative path of said plurality of relative paths, wherein said second relative path includes said first embracing element;
concatenate said plurality of relative paths to generate said associated path in response to said second relative path including a root element associated with said electronic document; and
utilize said associated path to locate said data element within said document hierarchy.

32. The location information module according to claim 30, wherein said location information module is further configured to process an XML formatted electronic document.

33. The location information module according to claim 32, wherein said location information module is further configured to process an XPath expression.
